(19) United States
(12) Patent Application Publication
(10) Pub. No.: US 2004/0228144 A1
(43) Pub. Date: Nov. 18, 2004

(54) Remote source lighting apparatus and methods

(76) Inventor: John B. Squicciarini, Aliso Viejo, CA (US)

Correspondence Address: ROBERT D. FISH, RUTAN & TUCKER LLP, 611 ANTON BLVD 14TH FLOOR, COSTA MESA, CA, 92626-1931, US

(21) Appl. No.: 10/846,447

(22) Filed: May 14, 2004

Related U.S. Application Data
(60) Provisional application No. 60/471,128, filed on May 16, 2003.

(51) Int. Cl. F21V 25/00

(52) U.S. Cl. 362/555

(57) ABSTRACT

Remote source lighting methods and apparatus are provided that may be used individually or in any combination, preferably with LED illuminators used with side emitting optical fibers. In some instances, illuminators comprising multiple LEDs pointing in different directions as described herein are used as remote light sources. In some instances, remote lighting apparatus are used to illuminate all or portions of vehicles, building members, building materials, articles of clothing, and/or pieces of furniture. In some instances, remote lighting apparatus are used to illuminate apparatus that include but are not necessarily limited to wheelchairs, golf carts, baby carriages, bicycles, motorcycles, automobiles, trucks, vans, sport utility vehicles, tanks, submarines, shoes, jackets, vests, hats, helmets, baby cribs, floors, walls, ceilings, countertops, tiles and wood.

This application claims priority to U.S. application No. 60/471,128, filed May 16, 2003, which is incorporated herein by reference in its entirety.

### FIELD OF THE INVENTION

The field of the invention is remote source lighting.

### BACKGROUND OF THE INVENTION

Remote source lighting systems and methods such as the use of fiber optic and/or prism guides to transmit light are known and provide numerous advantages over more traditional lighting systems and methods. However, known remote source lighting apparatus and methods can still be improved to better achieve such advantages. As such, there is a continuing need for improvements to remote source lighting apparatus and methods.

### SUMMARY OF THE INVENTION

In accordance with this invention, remote source lighting methods and apparatus are provided that may be used individually or in any combination. In preferred embodiments, remote source lighting apparatus and methods include light emitting diode (LED) illuminators used with side emitting optical fibers.

In accordance with an aspect of this invention, optical fibers are coupled to apparatus by forming a channel in a surface of the apparatus

In accordance with an aspect of this invention, illuminators comprising multiple LEDs pointing in different directions as described herein are used as remote light sources.

In accordance with an aspect of this invention, illuminators having a cavity adapted to receive the end of an optical fiber where the cavity has a diameter or width smaller than the exterior diameter or width of the fiber to be received are used.

In accordance with an aspect of this invention, tools are used to reduce and roughen the exterior diameter of optical fibers prior to coupling such optical fibers to illuminators.

In accordance with an aspect of this invention, lighting methods and apparatus are used to illuminate all or portions of vehicles, building members, building materials, articles of clothing and/or pieces of furniture may be particularly enhanced by having a side emitting optical fiber integrated into them. Such apparatus may include but are not necessarily limited to wheelchairs, golf carts, baby carriages, bicycles, motorcycles, automobiles, trucks, vans, sport utility vehicles, tanks, submarines, shoes, jackets, vests, hats, helmets, baby cribs, floors, walls, ceilings, counter tops, tiles, and wood. If optical fibers are integrated into building structures, they may be used to define one or more paths between locations.

In accordance with an aspect of this invention, remote source lighting systems and methods described herein will comprise or use one or more illuminators powered by one or more of a variety of power sources. Such power sources may comprise any type of power source but it is contemplated that in some instances such power sources will comprise one or more of the following: power provided by a power company; locally generated/converted power; and/or stored power. As examples, household/line voltage may be provided via a standard wall outlet, locally generated/converted power may be provided via one or more photoelectric cells or inductive coils, and stored power may be provided by one or more batteries and/or capacitors. In some instances, it is desirable that the power source be adequate to power any illuminators it is coupled to continuously for weeks, months, or even years at a time.

In accordance with an aspect of this invention, at least some remote source lighting systems and methods described herein will comprise or use means for switching illuminators on or off wherein such means comprise one or more motion detectors, photo-electric sensors, and/or any means for sensing the presence of a person.

In accordance with an aspect of this invention, at least some remote source lighting systems and methods described herein will comprise one or more single and/or multiple color LEDs including but not necessarily limited to red LEDs, blue LEDs, green LEDs, yellow LEDs, RGB LEDs and LED clusters.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a remote source lighting (RSL) system.

FIG. 2 is a perspective view of a RSL system.

FIG. 3 is a perspective view of a RSL system.

FIG. 4A is a perspective view of a RSL system.

FIG. 4B is a cutaway view of a light guide.

FIG. 4C is a cutaway view of a light guide.

FIG. 4D is a perspective view of a light guide.

FIG. 4E is a perspective view of a light guide.

FIG. 4F is a perspective view of a light guide.

FIG. 5 is a cutaway view of a linear bi-directional illuminator.

FIG. 6 is a cutaway view of a perpendicular bi-directional illuminator.

FIG. 7 is a cutaway view of a linear bi-directional LED illuminator.

FIG. 8 is a cutaway view of a perpendicular bi-directional LED illuminator.

FIG. 9 is a cutaway view of a uni-directional LED illuminator.

FIG. 10 is a cutaway view of a reflecting end cap.

FIG. 11 is a cutaway view of an optical fiber coupled to an illuminator.

FIG. 12A is a side view of an optical fiber.

FIG. 12B is a side view of the optical fiber of FIG. 12A having a reduced end diameter.

FIG. 12C is an end view of the fiber of FIG. 12B.

FIG. 13A is a side view of a fiber diameter reduction tool.

FIG. 13B is a front view of the tool of the tool of FIG. 13A.

FIG. 13C is atop view of the tool of FIG. 13A.

FIG. 13D is a cutaway side view of the tool of FIG. 13A.

### DETAILED DESCRIPTION

RLSs

In FIG. 1, a remote source lighting system (RSL system) 100 comprises an illuminator 110 coupled to a light guide 120 and a power source 190 via a power conductor assembly 191. In preferred embodiments illuminator 110 is an LED illuminator, light guide 120 is a side emitting optical fiber, and power source 190 is any power source suitable for providing power to illuminator 110. Power conductor assembly 191 comprises one or more conductors that transmit power and possibly control signals between power source 190 and illuminator 110.

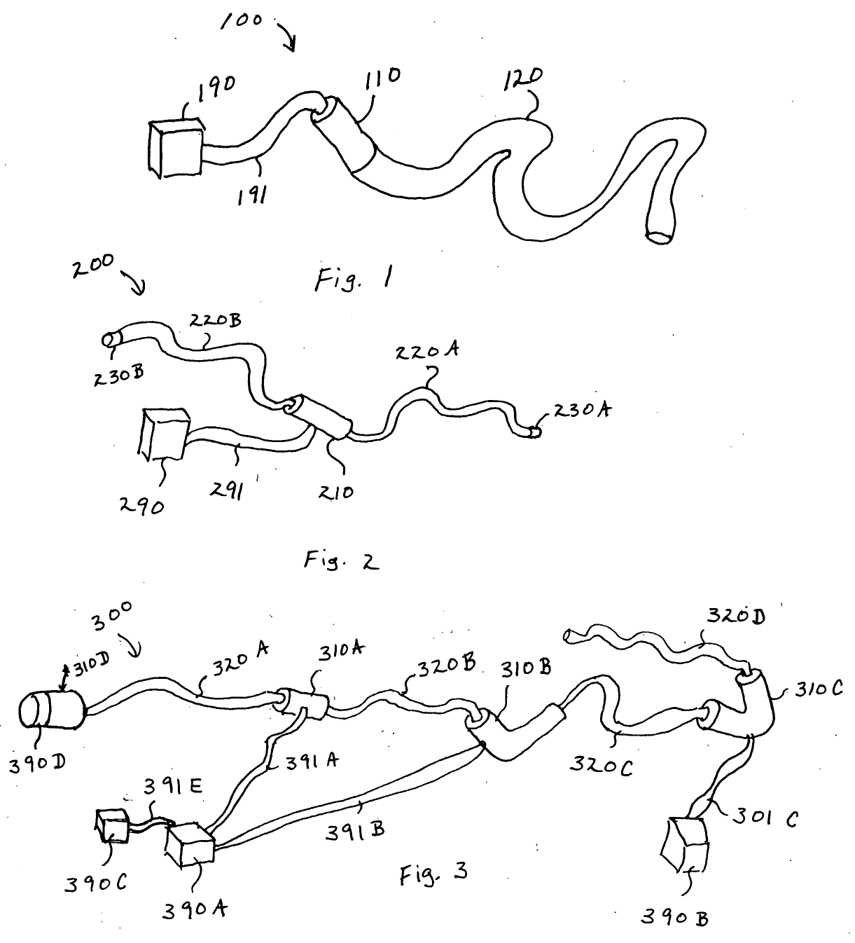

RSL systems may comprise multiple light guides, multiple illuminators, multiple power sources, and/or multiple illuminators. FIGS. 2 and 3 illustrate two alternative embodiments of RSL systems. In FIG. 2, RSL system 200 comprises illuminator 210, light guides 220A and 220B, end caps 230A and 230B, power source 290 and power conductor assembly 291. In FIG. 3, RSL system 300 comprises illuminators 310A-310D, light guides 320A-320D, power sources 390A-390D, and power conductor assemblies 391A-391E.

As show in FIG. 3, a power source may be a device such as 390A that receives power from another source such as 390C, or may be a incorporated into an illuminator such as power source 390D incorporated into illuminator 310D. If incorporated into an illuminator, a power source will generally comprise a form of stored energy such as can be provided by a battery or capacitor. If it receives power from another source, a power source (390A) may be used to convert and control the power from the other source (390C). In such instances source 390C may an electrical utility company, a local generator, a bank of photovoltaic sells, a wind turbine, or any other type of power source, and source 390A a transformer, control circuit, or any other form of power converter and/or controller. In some instances a first power source (390A) may be used to supplement a second power source (390C).

RSL systems may comprise different types of light guides. Essentially any light guide capable of transmitting and emitting light from a light source may be used. Any such light emitted by light guide 120 may be emitted uniformly along the length of guide 120, or may be emitted in at regular or varying intensities and/or at regular or irregular intervals along the length of guide 120.

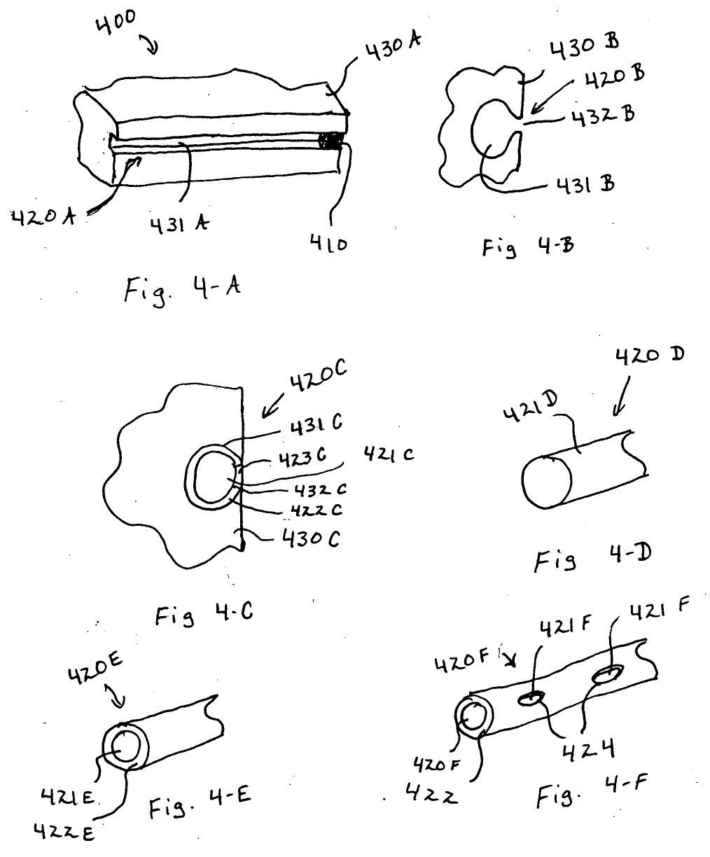

In some instances, light guides will utilize a gaseous mixture such as air as a transmission medium while in other instances the transmission medium may comprise a super cooled liquid such as glass, or a solid such as a transparent or translucent (non-opaque) plastic. In some instances light guides will stand alone while in other instances they will be incorporated into larger structures. FIGS. 4A-4C illustrate light guides incorporated into larger structures. In FIG. 4A, a RSL system 400 comprises an emitter 410 and a light guide 420 where light guide 420 comprises a channel 431A cut into body 430A. Although the channel of FIG. 4A has a rectangular cross section, other channel shapes may be used as well as is illustrated in FIG. 4B where light guide 420B comprises channel 4311B in body 430B and channel 4311B intersects a surface of body 430B at slit 432B.

FIG. 4C illustrates a light guide 420C incorporated into body 430C wherein the light guide comprises channel 431C, slit 432C, core 421C, cladding 422C, and window 432C. The light guide of FIG. 4C differs from that of FIGS. 4A and 4B in that it incorporates a non-gaseous core in channel 431C. The use of a non-gaseous core is advantageous in non-linear light guides as it facilitates transmission of light along the length of a guide that isn't laid out as a straight line. Cladding 422C may be adapted to facilitate transmission of light along core 421C and/or may facilitate retaining core 421C within channel 431C. If intended to seal core 421C into channel 431C, cladding 422C may advantageously comprise epoxy, silicon glue, and/or some type of pliable adhesive and/or bonding material used to fill the space between core 421C and the wall(s) of channel 431C. Window 432C may simply be an open area in slit 432C or may comprise a non-opaque material that permits light emitted from core 431C to pass through slit 432C.

If a light guide comprises a non-gaseous core, a supporting structure may not be necessary. As shown in FIG. 4D, a light guide 420D may simply comprise a non-opaque core 421D. In some instances, even without a supporting structure, a light guide may utilize a cladding material enclosing a core such as in FIGS. 4E and 4F. In FIG. 4E, light guide 420E comprises a core 421E and cladding 422E. In FIG. 4F, light guide 420F comprises core 421F, cladding 422F, and windows 424. Windows 424 function to allow light emitted by core 421F to pass through cladding 422E. Windows 424 may simply comprise openings in cladding 422F or may be openings in cladding 422F filled with a non-opaque material.

RSL systems may comprise different types of illuminators. As such, an illuminator (110 in FIG. 1, 210 in FIG. 2, 310A-310D in FIG. 3, and 410 in FIG. 4A) may comprise any appropriate light source such as an LED, laser, light bulb, laser diode, etc. In preferred embodiments illuminators will be LED illuminators that use one or more LEDs as a light source.

I. Bi-Directional Illuminators

In many applications a bi-directional illuminator (BDI), an illuminator comprising at least two light sources emitting light in different directions, can be advantageously used to couple multiple light guides together as shown in FIG. 3. In FIG. 3, illuminators 310A-310C are each a BDI. Linear BDI 310A comprises two light sources pointing in opposite directions and is particularly well adapted for use when an RLS systems comprises multiple light guides arranged linearly. In comparison, BDIs 310B and 310C comprise light sources that are not oriented along a common line but which are directed perpendicular to each other as in perpendicular BDI 310B, or non-linearly and non-perpendicularly as in angled BDI 310C. It is contemplated that the use of BDIs and multiple light guides may be used to provide the appearance one or more long light guides without the incurring the problems in light distribution typically encountered with such long light guides.

FIGS. 5-10 illustrate illuminators and end-caps suitable for use as shown in FIGS. 1-3. In FIG. 5, illuminator 510 comprises two light sources, 513A and 513B oriented to emit light in opposite directions along axis 5-5. In addition to light sources 513A and 513B, illuminator 510 comprises cylindrical housing 511, input connector 512, light source controllers 514A and 514B, conductors 515A and 515B electrically coupling light source controllers 514A and 514B to input connector 512, and light guide receiving cavities 519A and 519B.

In FIG. 6, perpendicular bi-directional illuminator 610 comprises two light sources, 613A and 613B oriented to emit light along two perpendicular axis BA2 and BA3. In addition to light sources 613A and 613B, illuminator 610 comprises housing 611, input connector 612, controller 614, conductors 615A, 615B and 615C electrically coupling light sources 613A and 613B to controller 614 and controller 614 to input connector 612, and also comprises light guide receiving cavities 619A and 619B.

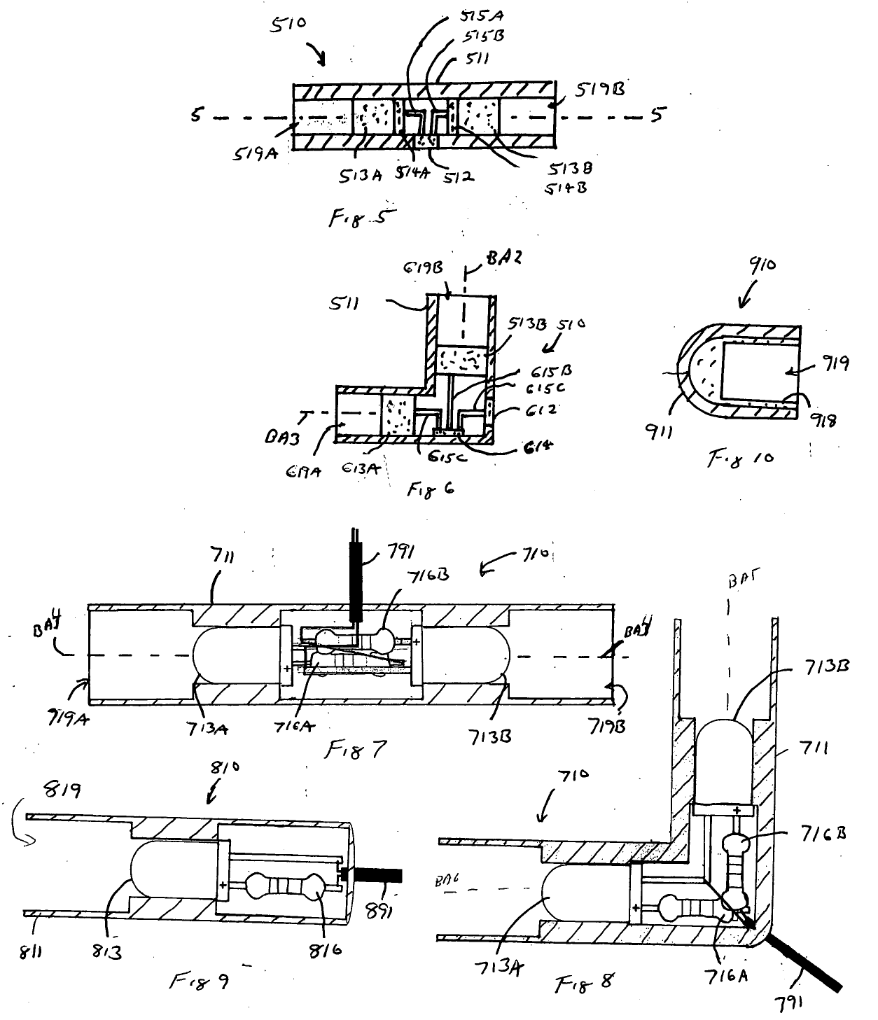

In FIG. 7, LED illuminator 710 comprises two LEDs 713A and 713B oriented to emit light in opposite directions along axis BA4. In addition to LEDs 713A and 713B, illuminator 710 comprises cylindrical housing 711, resistors 716A and 716B, and two-conductor wire 791.

In FIG. 8; perpendicular bi-directional illuminator 710 comprises two LEDs 713A and 713B oriented to emit light along two perpendicular axis BA5 and BA6. In addition to LEDs 713A and 713B, illuminator 710 comprises housing 711, resistors 716A and 716B, and two-conductor wire 791.

In FIG. 9, unidirectional LED illuminator 810 comprises a single LED 813, housing 811, light guide receiving cavity 819, resistor 816, and two-conductor wire 891.

In FIG. 10, reflecting end-cap 910 comprises housing 911, reflecting surface 918, and light guide receiving cavity 919.

II. Coupling Methods

RSL systems may utilize different methods for coupling illuminators to light guides to permit the illuminators to transmit light through the light guides. However, a preferred method of coupling light guides to illuminators when the light guide is a fiber optic cable is to reduce the diameter or width of an end of the fiber optic and to insert the reduced end into a portion of the illuminator adapted to receive such an end. In some instances the end will simply be pressed into the illuminator while in other instances it will be adhesively or otherwise fastened within the illuminator. FIG. 11 illustrates a reduced end diameter optical fiber 950 coupled to illuminator 951. Illuminator 951 comprises a light source 952 oriented to transmit light into the end 953 of fiber 954 inserted into illuminator 951. It should be noted that, as shown, the diameter of end 953 is smaller than that of the most of the body 955 of fiber 954.

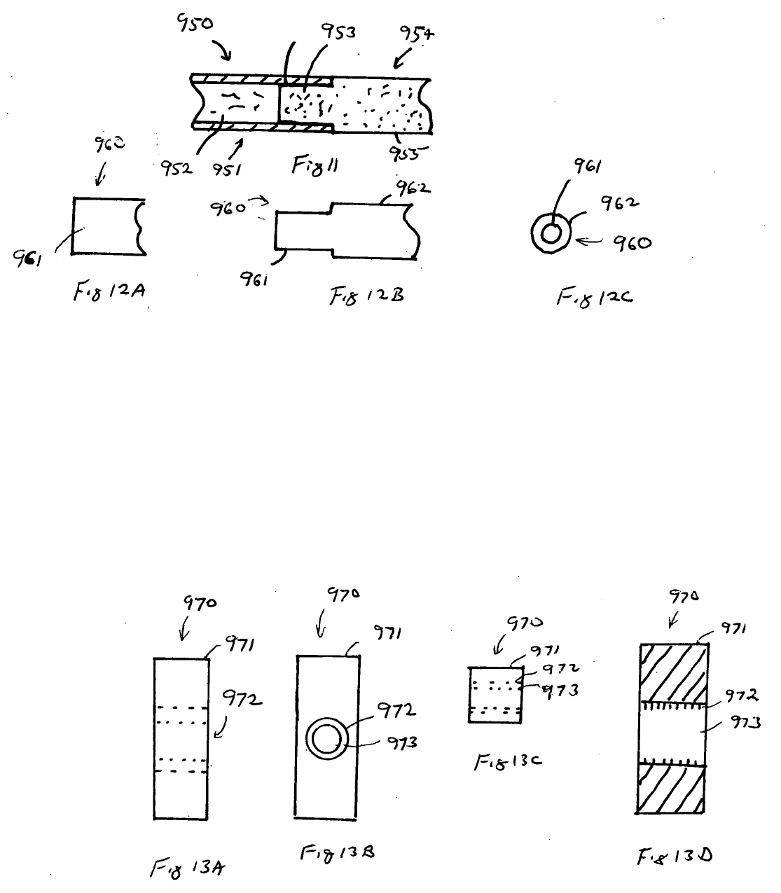

FIGS. 12A-12C illustrate how an optical fiber may be modified in preparation for it being coupled to an illuminator. FIG. 12A shows an optical fiber 960 having an end 961 that is the same diameter as the rest of fiber 960. The same fiber and end are illustrated in FIGS. 12B and 12C after the diameter of end 961 has been reduced such that it is smaller than that of body 962.

When a method requiring that the end of a fiber optic cable be reduced in size is used, it is preferably to use a tool adapted to that purposed. As shown in FIGS. 13A-13D a tool 970 comprises a body 971 having at least one fiber receiving cavity 972. Cavity 970 may extend either partially into or fully through the body 971 and is preferably lined with a mechanism 973 for removing a portion of a fiber optic cable inserted into the cavity. Such a mechanism 973 might comprise a number of thin wires projecting towards the center of the cavity from the wall of the cavity similar to bristles on a brush. Rotating the fiber and the tool relative to each other such that the tool essentially rotates about the fiber will cause the wires to remove portions of the fiber. Moreover, because the fiber is reduced in size by abrasion, the resultant surface will be substantially rougher than the original surface of the fiber and will thus be better adapted for being adhesively bonded to an illuminator.

What is claimed is:

1. A remote lighting source (RLS) comprising an LED illuminator coupled to a side emitting optical fiber.

2. The RLS of claim 1 comprising at least two fiber optic segments coupled together by a bidirectional illuminator.

3. The RLS of claim 2 wherein the illuminators are spaced at least X feet apart where X is one of 2, 5, 10, 15, and 20.

4. The RLS of claim 3 comprising a plurality of fiber optic segments wherein each segment comprises two ends and each end is coupled to either an illuminator or a reflecting end cap.

5. The RLS of claim 1 comprising a side emitting fiber at least partially encased in an opaque sleeve.

6. The apparatus of claim 5 wherein the sleeve comprises a plurality of opening extending between an outer surface of the sleeve and the encased side emitting fiber.

7. The apparatus of claim 6 wherein each of the plurality of openings is filled with a translucent or transparent material.

8. The apparatus of claim 5 wherein the opaque sleeve forms a reflective surface wherever it contacts the fiber it encases.

9. A method of illuminating an apparatus comprising coupling the RLS of claim 1 to the apparatus and providing power to the illuminator so as to cause the illuminator to transmit light into the side emitting optical fiber.

10. The method of claim 9 wherein the apparatus is one of a wheelchair, golf cart, baby carriage, bicycle, motorcycle, automobile, truck, van, sport utility vehicle, tank, submarine, shoe, jacket, vest, hat, helmet, baby crib, floor, wall, ceiling, counter top, tile, and wood panel.

11. An illuminator comprising at least two RGB LEDs wherein there is at least a 30 degree separation between the LEDs.

12. The illuminator of claim 11 wherein there is a ninety degree separation between the LEDs.

13. The illuminator of claim 11 wherein there is a one hundred and eight degree separation between the LEDs.

14. A method of coupling an illuminator to an optical fiber comprising decreasing the diameter or width of an end of the fiber and inserting that end into an inlet in the illuminator.

15. The method of claim 14 further comprising bonding the end of the fiber inserted into the illuminator to the illuminator.
